(19) United States
(12) Patent Application Publication
(10) Pub. No.: US 2025/0342674 A1
(43) Pub. Date: Nov. 6, 2025

(54) Methods and Systems for Generating Training Images for Use in Security Inspection Machine Learning Systems

(71) Applicant: Rapiscan Holdings, Inc., Hawthorne, CA (US)

(72) Inventors: James Ollier, Huyton (GB); Mark Procter, Wilmslow (GB); Steven Bourne, Stoke-on-Trent (GB)

(21) Appl. No.: 19/178,308

(22) Filed: Apr. 14, 2025

Related U.S. Application Data
(60) Provisional application No. 63/642,266, filed on May 3, 2024.

(51) Int. Cl. G06T 19/20; G06T 15/20

(52) U.S. Cl. CPC G06T 19/20; G06T 15/20; G06T 2219/2004; G06T 2219/2016

(57) ABSTRACT

A method for generating two dimensional (2D) radiographic like images of a threat item from a 3D model of the item includes: constructing a 3D model of an illicit material and/or threat item by using a computer graphics (CG) process; making the 3D model at least partially transparent to light; changing orientation of the 3D model one or more times; and rendering the 3D model to generate a plurality of 2D radiographic like images, wherein a number of 2D images rendered is dependent upon the number of times the orientation of the 3D model is changed.

### CROSS-REFERENCE

The present application relies on, for priority, U.S. Patent Provisional Application No. 63/642,266, titled “Methods and Systems for Generating Training Images for Use in Security Inspection Machine Learning Systems” and filed on May 3, 2024, which is herein incorporated by reference in their entirety.

### FIELD

The present specification relates to methods for generating synthetic radiographic images. In particular, the present specification relates to generating radiographic-like images from computer generated 3D models of threat items for training computer vision models and tools.

### BACKGROUND

X-ray inspection systems are commonly used to detect illicit materials and/or threat items hidden in baggage, cargo containers, vehicles, or on personnel at security check points. Radiographic images obtained by the x-ray inspection systems are required to be manually viewed and interpreted by system operators in order to ascertain whether an illicit material and/or threat item is present. A variety of Artificial Intelligence (AI) based machine vision tools or models are being developed to aid operators to spot illicit materials and threat items in the radiographic images. The machine vision tools or models must be trained in order to provide an accurate result that the operators may have confidence in and rely upon.

In order to train the models, a plurality of radiographic images of the illicit materials and/or threat items contained within stream-of-commerce radiographic images must be input into the models, for learning to identify illicit materials and/or threat items hidden in a stream of commerce (SoC) radiographic image. FIG. 1 is a flowchart illustrating training AI-based vision models for detecting illicit materials and/or threat items. At step 102, a plurality of radiographic images of the illicit materials and/or threat items contained within stream-of-commerce radiographic images are obtained. At step 104, the obtained images are input into an AI-based vision model for training the model to correctly detect the illicit materials and/or threat items hidden within baggage, cargo containers, or vehicles.

It is, however, difficult to obtain a large quantity of radiographic images of illicit materials and/or threat items hidden in a variety of inspection environments and/or scenarios, for training the machine learning vision models. Hence, there is need for an accurate and inexpensive method of generating synthetic images of illicit materials and/or threat items hidden in baggage and/or cargo and containers that can be inserted within a stream of radiographic images obtained from an X-ray screening machine. Further, there is need for an accurate and inexpensive method of generating said synthetic images wherein the illicit materials and/or threat items may be imaged in multiple orientations and a plurality of configurations.

### SUMMARY

The following embodiments and aspects thereof are described and illustrated in conjunction with systems, tools and methods, which are meant to be exemplary and illustrative, and not limiting in scope. The present application discloses numerous embodiments.

The present specification is directed to a method for generating two dimensional (2D) radiographic-like images of an item from a three dimensional (3D) virtual model of the item, the method comprising: constructing the virtual 3D model of the item, wherein the item is an illicit material and/or threat item, by using a computer graphics (CG) process; modifying a degree of visual transparency of the virtual 3D model; modifying an orientation of the virtual 3D model more than once; and upon the virtual 3D model adopting each modified orientation, automatically rendering the virtual 3D model to generate at least one of the 2D radiographic-like images representative of said modified orientation, wherein a number of the generated 2D radiographic-like images is dependent upon a number of times the orientation of the virtual 3D model is modified.

Optionally, the method further comprises importing the constructed virtual 3D model into a simulation software application. Optionally, the method further comprises assigning each part of the virtual 3D model a distinct material composition type. Optionally, the method further comprises associating each of the assigned distinct material composition type with a corresponding attenuation coefficient. Optionally, the method further comprises, after changing the orientation of the virtual 3D model, scanning the virtual 3D model by using a simulation software application. Optionally, rendering the virtual 3D model to generate the 2D radiographic-like image comprises extracting the 2D radiographic-like image from the simulation software application.

Optionally, the simulation software application is a Monte-Carlo type simulation application.

Optionally, the method further comprises adding a noise element to the generated 2D radiographic-like image. Optionally, the method further comprises adding said noise element using a filtering process or a randomizing process.

Optionally, the method further comprises re-sizing the generated 2D radiographic-like image to fit with a predefined resolution of one or more machine learning based inspection tools.

The present specification also discloses a method for generating a plurality of two dimensional (2D) radiographic-like images of an item from a virtual 3D model of the item, the method comprising: constructing the virtual 3D model of the item, wherein the item is an illicit material and/or threat item, by using a computer graphics (CG) process; importing the constructed virtual 3D model into a simulation software application; assigning each part of the virtual 3D model a distinct material composition type; associating each of the assigned distinct material composition types with a corresponding attenuation coefficient; modifying an orientation of the virtual 3D model one or more times; scanning the virtual 3D model using the simulation software application; and automatically generating the plurality of 2D radiographic-like images from the simulation software application.

Optionally, the simulation software application is a Monte-Carlo type simulation application.

Optionally, a number of the plurality of 2D radiographic like images generated is dependent upon a number of times the orientation of the virtual 3D model is modified.

Optionally, the method further comprises adding a noise element to each of the generated plurality of 2D radiographic like images. Optionally, said noise element is added using a filtering process or a randomizing process.

Optionally, the method further comprises re-sizing each of the generated plurality of 2D radiographic like images to fit with a predefined resolution of one or more machine learning based inspection tools.

The present specification also discloses a method of generating radiographic-like images of vehicles and cargos containers containing threat items, the method comprising: generating three-dimensional (3D) models of a plurality of types of threat items using a computer graphics (CG) process; generating 3D models of a plurality of types of vehicles by using said CG process; generating 3D models of a plurality of types of cargo containers by using said CG process; generating realistic inspection scenarios using multiple configurations of the different 3D models of the plurality of types of threat items, 3D models of the plurality of types of vehicles, and 3D models of the plurality of types of cargo containers; and generating two dimensional radiographic-like images from said realistic inspection scenarios.

Optionally, generating realistic inspection scenarios is achieved by using a randomizer to make random selections of configurations of the 3D models of the plurality of types of vehicles and 3D models of the plurality of types of cargo containers and positions of the 3D models of the plurality of types of threat items within the 3D models of the plurality of types of vehicles and the 3D models of the plurality of types of cargo containers.

Optionally, generating the radiographic like images comprises rendering 3D models representing realistic inspection scenarios and generating each of the 2D radiographic like images from said 3D models representing realistic inspection scenarios.

Optionally, generating the two dimensional radiographic like images comprises: importing the 3D models representing realistic inspection scenarios into the simulation software application; assigning each part of the 3D models representing realistic inspection scenarios a distinct material composition type; associating each of the assigned materials with a corresponding attenuation coefficient; changing orientation of the 3D models representing realistic inspection scenarios at least once; scanning the 3D models representing realistic inspection scenarios using the simulation software application; and extracting the 2D radiographic like images from the simulation software application.

In some embodiments, the present specification discloses a method for generating two dimensional (2D) radiographic like images of a threat item from a three dimensional (3D) model of the item, the method comprising: constructing a 3D model of an illicit material and/or threat item by using a computer graphics (CG) process; making the 3D model at least partially transparent to light; changing an orientation of the 3D model one or more times; and rendering the 3D model to generate a plurality of 2D radiographic images, wherein a number of 2D images rendered is dependent upon the number of times the orientation of the 3D model is changed.

Optionally, the method further comprises importing the constructed 3D model into a simulation software application.

Optionally, the method further comprises assigning each part of the 3D model a distinct material.

Optionally, the method further comprises associating each of the assigned materials with a corresponding attenuation coefficient.

Optionally, the method further comprises scanning the 3D model by using the simulation software application after changing an orientation of the 3D model one or more times.

Optionally, the rendering the 3D model to generate a plurality of 2D radiographic images comprises extracting one or more 2D radiographic like images from the simulation software application.

Optionally, the simulation software application is Monte-Carlo simulation application.

Optionally, the method further comprises adding noise elements to the generated 2D radiographic like images. Optionally, noise is added to the 2D radiographic like images by using a filtering or a randomizing process.

Optionally, the method further comprises re-sizing the generated 2D radiographic like images to fit with predefined resolutions of one or more machine learning based inspection tools.

In some embodiments, the present specification describes a method for generating 2D radiographic like images of a threat item from a 3D model of the item, the method comprising: constructing a 3D model of an illicit material and/or threat item by using a computer graphics (CG) process; importing the constructed 3D model into a simulation software application; assigning each part of the 3D model a distinct material; associating each of the assigned materials with a corresponding attenuation coefficient; changing an orientation of the 3D model one or more times; scanning the 3D model by using the simulation software application; and extracting one or more 2D radiographic like images from the simulation software application.

Optionally, the simulation software application is a Monte-Carlo simulation application.

Optionally, a number of 2D images rendered is dependent upon the number of times the orientation of the 3D model is changed.

Optionally, the method further comprises adding noise elements to the generated 2D radiographic like images. Optionally, noise is added to the 2D radiographic like images by using a filtering or a randomizing process.

Optionally, the method further comprises re-sizing the generated 2D radiographic like images to fit with predefined resolutions of one or more machine learning based inspection tools.

In some embodiments, the present specification describes a method of using computer graphics technology to generate radiographic like images of vehicles and cargos containers containing threat items, the method comprising: constructing three-dimensional (3D) models of a plurality of types of threat items by using a computer graphics (CG) process; constructing 3D models of a plurality of types of vehicles by using a CG process; constructing 3D models of a plurality of types of cargo containers by using a CG process; creating realistic inspection scenarios by using multiple configurations of the different 3D models of the plurality of types of threat items, 3D models of the plurality of types of vehicles, and 3D models of the plurality of types of cargo containers; and generating two dimensional radiographic like images by using the realistic inspection scenarios.

Optionally, creating realistic inspection scenarios is achieved by using a randomizer to make random selections of configurations of the 3D models of vehicles and cargo containers and positions of the 3D models of the threat items within the 3D models of vehicles and cargo containers.

Optionally, generating the two dimensional radiographic like images comprises rendering the 3D models representing realistic inspection scenarios to generate a plurality of 2D radiographic like images.

Optionally, generating the two dimensional radiographic like images comprises: importing the 3D models representing realistic inspection scenarios into a simulation software application; assigning each part of the 3D models a distinct material; associating each of the assigned materials with a corresponding attenuation coefficient; changing orientation of the 3D models one or more times; scanning the 3D models by using the simulation software application; and extracting one or more 2D radiographic like images from the simulation software application.

The aforementioned and other embodiments of the present specification shall be described in greater depth in the drawings and detailed description provided below.

### BRIEF DESCRIPTION OF THE DRAWINGS

The accompanying drawings illustrate various embodiments of systems, methods, and embodiments of various other aspects of the disclosure. Any person with ordinary skill in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 is a flowchart showing steps of a method of training artificial intelligence (AI)-based vision models for detecting illicit materials and/or threat items;

FIG. 2 is a flowchart showing steps of a method for training AI-based vision models comprising staging an x-ray inspection scenario;

FIG. 3 is a flowchart showing steps of a method for inserting synthetic images of illicit materials and/or threat items into real stream of commerce radiographic images for training AI-based vision models;

FIG. 4 is a flowchart detailing steps of a method for generating a 3D model of a threat item that may be used to obtain two-dimensional (2D) radiographic like images of the threat item, in accordance with an embodiment of the present specification;

FIG. 5A is a graphical user interface of an exemplary software application that is used to generate a 3D model of a threat item, in accordance with an embodiment of the present specification;

FIG. 5B illustrates a computer generated (CG) model of an assault rifle, in accordance with an embodiment of the present specification;

FIG. 6 is a flowchart detailing steps of a method for generating a 3D model of a threat item that may be used to obtain 2D radiographic-like images of the threat item by using a simulation software application, in accordance with an embodiment of the present specification;

FIG. 7A is a flowchart detailing steps of a method for using computer generated imaging (CGI) to generate radiographic like images of cargo containers and vehicles containing threat items, in accordance with an embodiment of the present specification; and

FIG. 7B illustrates an X-ray source and detector array pictured in a simulation application for simulating a transmission style x-ray inspection system, in accordance with an embodiment of the present specification.

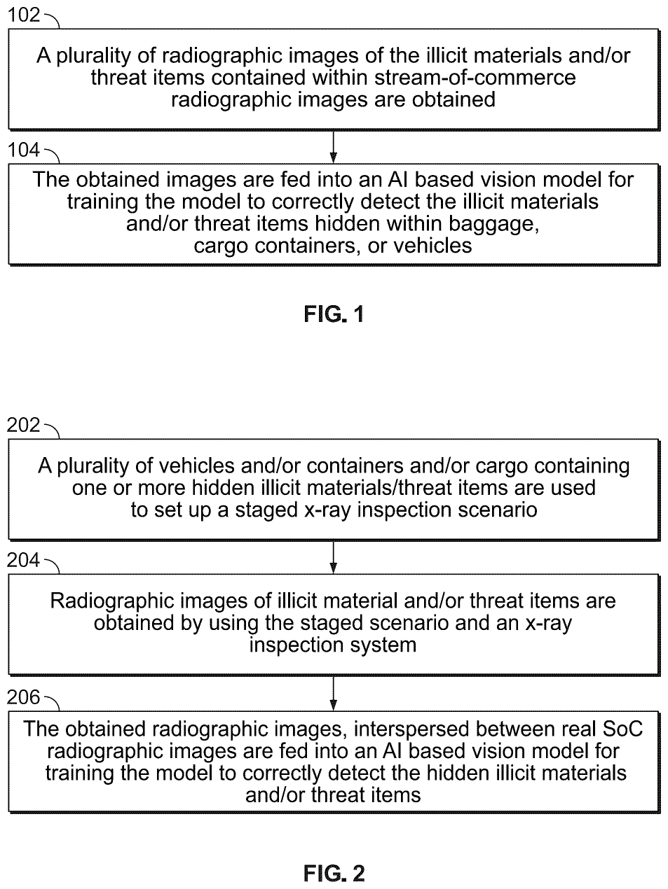

### DETAILED DESCRIPTION

The present specification provides methods of using computer generated imaging and/or modeling techniques (CGI) for generating three-dimensional (3D) models of illicit materials and/or threat items. The generated 3D models are then used to obtain two-dimensional (2D) radiographic-like images of the corresponding illicit materials and/or threat items, which may then be used in a Threat Image Projection (TIP) system that is used to train operators.

In some embodiments, the present specification describes methods and systems that employ artificial intelligence (AI) models using neural networks, machine learning, machine vision, or other deep learning processes that use radiographic images of illicit materials and/or threat items hidden in a variety of inspection environments and/or scenarios, for training the machine learning vision models. Thus, in embodiments, systems and methods of the present specification are configured to generate synthetic radiographic-like images of illicit materials and/or threat items hidden in baggage and/or cargo and/or containers in multiple orientations and configurations that can be inserted within a stream of radiographic images obtained from an X-ray screening machine.

In some other embodiments, the present specification describes methods and systems for generating synthetic threat images that may be inserted within stream of commerce radiographic images obtained from an X-ray screening machine, to train computer models for identifying threat items passing through the X-ray screening machine. In embodiments, the present specification provides methods of using computer generated imaging and/or modeling techniques (CGI) for generating three-dimensional (3D) models of illicit materials and/or threat items. The generated 3D models are then used to obtain two dimensional (2D) radiographic-like images of the corresponding illicit materials and/or threat items, which can be subsequently used for machine learning and training of AI based vision tools. Thus, in some embodiments, the AI-based system of the present specification may then be configured and used to generate additional images which may be used in a Threat Image Projection (TIP) system that is used to train operators. In some other embodiments, the AI-based system may be used to analyze scan images to help identify threats directly and make a determination as to whether a threat exists.

In embodiments, the present specification provides methods of using computer generated imaging and/or modeling techniques (CGI) for generating three-dimensional (3D) models of illicit materials and/or threat items, which are then used to obtain two dimensional (2D) radiographic-like images of the corresponding illicit materials and/or threat items. In embodiments, the generated images are used in the context of a Threat Image Projection (TIP) system that is used to train operators. In embodiments, the output of the operator training process, including identifying images that contain threats, images of threat items, or clearing images that do not contain threat items, is then input into an AI-based system. The AI-based system may then be used to generate additional images, using the systems and methods of the present specification and used in a system to train operators. In some other embodiments, the AI-based system may be used to analyze scan images to help identify threats directly and make a determination as to whether a threat exists.

Thus, the 3D CGI simulation software to 2D rendering approach of the present specification can be used to i) generate images that are used directly within a TIP system to train operators; ii) generate images that are used to first train an AI-based system, which can then be used to train operators within a TIP system or analyze scan images directly; or iii) generate images which are used within a TIP system to train operators, where the output of the operator training process is then used to train an AI-based system for generating additional images that are used to further train operators within the TIP system or used to analyze scan images directly. It should be noted herein that while the process may be described in the context of certain embodiments, different portions of each disclosed process may be selectively combined to arrive at the many different embodiments that the present specification is intended to cover.

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For the purpose of clarity, details relating to technical material that is known in the technical fields related to the invention have not been described in detail so as not to unnecessarily obscure the present invention.

In various embodiments, a computing device includes an input/output controller, at least one communications interface and system memory. The system memory includes at least one random access memory (RAM) and at least one read-only memory (ROM). These elements are in communication with a central processing unit (CPU) to enable operation of the computing device. In various embodiments, the computing device may be a conventional standalone computer or alternatively, the functions of the computing device may be distributed across multiple computer systems and architectures.

In some embodiments, execution of a plurality of sequences of programmatic instructions or code enables or causes the CPU of the computing device to perform various functions and processes. In alternate embodiments, hard-wired circuitry may be used in place of, or in combination with, software instructions for implementation of the processes of systems and methods described in this application. Thus, the systems and methods described are not limited to any specific combination of hardware and software.

The term “module” or “engine” used in this disclosure may refer to computer logic utilized to provide a desired functionality, service or operation by programming or controlling a general-purpose processor. Stated differently, in some embodiments, a module or engine implements a plurality of instructions or programmatic code to cause a general-purpose processor to perform one or more functions. In various embodiments, a module or engine can be implemented in hardware, firmware, software or any combination thereof. The module or engine may be interchangeably used with unit, logic, logical block, component, or circuit, for example. The module or engine may be the minimum unit, or part thereof, which performs one or more particular functions.

It should be understood that each component described herein is configured to perform the functions that it is described to perform.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items or meant to be limited to only the listed item or items. It should be noted herein that any feature or component described in association with a specific embodiment may be used and implemented with any other embodiment unless clearly indicated otherwise.

It should also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

FIG. 2 illustrates a method for training the AI-based vision models comprising staging an x-ray inspection scenario. As shown in FIG. 2, at step 202, a plurality of vehicles and/or containers and/or cargo containing one or more hidden illicit materials and/or threat items are used to set up a staged x-ray inspection scenario. A staged X-ray inspection scenario comprises generation of radiation (X-ray) images using real objects and an X-ray inspection system, which is performed in a controlled setting where the objects are known. At step 204, radiographic images of illicit materials and/or threat items are obtained by using the staged scenario and an x-ray inspection system. At step 206 the obtained radiographic images, interspersed between real stream of commerce (“SoC) SoC radiographic images are input into an AI-based vision model for training the model to correctly detect the hidden illicit materials/threat items.

In order for AI-based vision models to learn to identify illicit materials and/or threat items and apply the learning to real life scenarios, the models are required to a) be able to generalize the features that make a material illicit or an item to be labeled as a ‘threat item’ and b) be able to eliminate the materials and items that are not illicit or pose a threat. Therefore, for the method shown in FIG. 2 to succeed in training the vision models, multiple trucks and/or containers would need to be used along with different cargo to produce multiple, varying staged inspection scenarios and/or configurations. Hence, as would be understood by persons of skill in the art, the method shown in FIG. 2 would prove to be impractical, expensive and difficult to achieve.

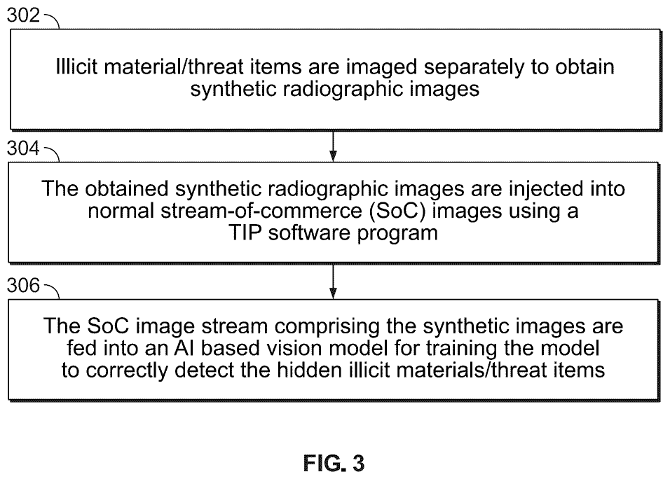

In some cases, a threat image projection (TIP) method is used for training AI-based vision models. TIP is a software program that inserts images of actual synthetic threat items into the real images of real items that are being screened using X-ray inspection systems. Thus, the threat items are referred to, in embodiments, as synthetic because they are imaged in a controlled environment and do not pose a threat in reality. FIG. 3 is a flowchart illustrating a method for inserting images of synthetic illicit materials and/or threat items into real SoC radiographic images for training AI-based vision models. At step 302, synthetic illicit materials and/or threat items are imaged separately to obtain radiographic images of synthetic illicit materials and/or threat items, or “synthetic” radiographic images. Thus, as used herein, “synthetic radiographic images” refer to actual radiographic images obtained using synthetic or innocuous threat items or objects that are used for generating the images in a controlled environment where the objects do not pose an actual threat. At step 304, the obtained synthetic radiographic images are injected into normal SoC images using a TIP software program. At step 306, the SoC image stream comprising the synthetic images are input or transmitted to an AI-based vision model for training the model to correctly detect the hidden illicit materials/threat items. By using the method illustrated in FIG. 3, illicit materials and/or threat items can be imaged in a controlled environment to generate synthetic images, where multiple orientations and configurations of the objects can be obtained. However, it is difficult to obtain different types of illicit materials and/or threat items for generating the synthetic images. Further, a controlled environment for x-ray imaging may not be accessible, and the time required to scan different forms of the illicit materials and/or threat items may be undesirably long. Purchasing the required synthetic images from third party vendors may make the AI vision model training process expensive and prone to errors as there may be inaccuracies in the purchased images.

Because it is difficult to obtain a large quantity of radiographic images of illicit materials and/or threat items hidden in a variety of inspection environments and/or scenarios for training the machine vision models, methods of the present specification improve upon those methods described in FIGS. 2 and 3 by providing an accurate and inexpensive method of generating synthetic images of illicit materials and/or threat items hidden in baggage and/or cargo and/or containers, which synthetic images are inserted within a stream of radiographic images obtained from an X-ray screening machine. In addition, synthetic images of the illicit materials and/or threat items may be generated in multiple orientations and a plurality of configurations.

In some embodiments, images may undergo at least one transformation in order to train the AI-based vision tools of the present specification. In embodiments, the possible transformations include, but are not limited to, orientation (x, y, and z-axis), size and/or resolution, and transparency. In embodiments, the systems and methods of the present specification are configured such that the threat items are learned from all angles and orientations. Further, embodiments are configured to learn to identify different resolutions, as the threat item may exhibit different features at different resolutions. Still further, the system of the present specification is configured to learn radiographic-like images because as with real systems, the actual radiographic images can vary in intensity as the energy of the X-rays vary. The variations result in possible changes in the transparency seen in the actual radiographic images. The AI-based tools need to learn to cope with this variation. Herein, radiographic-like images are the 2D renderings of threat items constructed using CGI, which is discussed further below. Therefore, in embodiments of the present specification, the radiographic-like images appear like real radiographic images with all the variations involved, so that the AI can learn the variations.

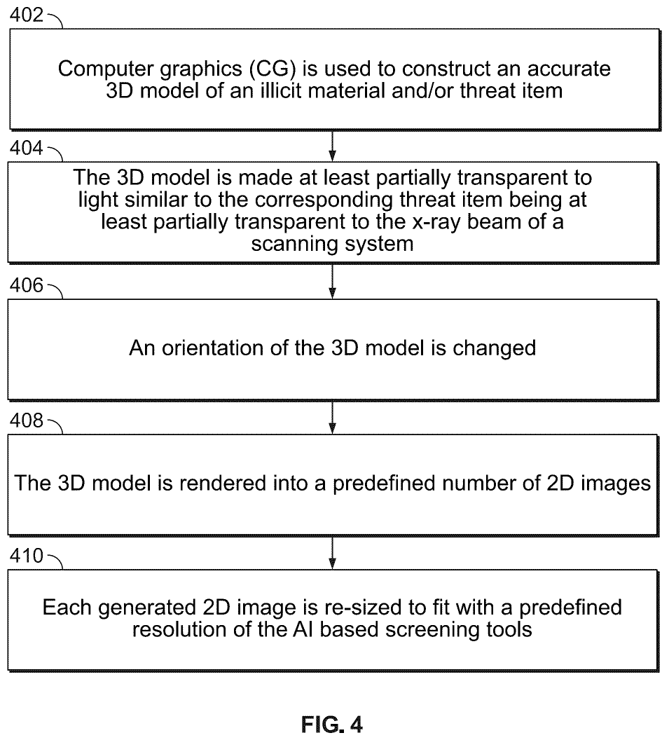

FIG. 4 is a flowchart detailing steps of a method for generating a 3D model of a threat item that may be used to obtain two-dimensional (2D) radiographic-like images of the threat item, in accordance with an embodiment of the present specification. At step 402, a computer graphics imaging (CGI) technique is used to construct an accurate 3D model of an illicit material and/or threat item. In some embodiments, the 3D model may be generated in a CGI environment for rendering directly to corresponding radiographic-like 2D images. In an alternative embodiment, pre-generated 3D models of objects are sources that are used by a CGI application to render corresponding radiographic-like images. Therefore, the 3D model may also be obtained from a third party. The 3D model is constructed such that it imitates or approximates an actual threat item being irradiated by X-rays, wherein at step 404, the 3D model is made at least partially transparent to light similar to the corresponding threat item being at least partially transparent to the x-ray beam of a scanning system. In embodiments, a level of transparency of each material represented in the 3D model is matched to an equivalent of a radiographic image of the corresponding threat item in order to enable a 2D radiographic-like image obtained from the model to match the grayscale values of an actual radiographic image of the corresponding threat item. In an embodiment, the grayscale value of each material represented in the 3D model is obtained by using the effective atomic number and thickness of each of the materials respectively.

In embodiments, in a radiographic image, transparency of an imaged material is directly proportional to the density, volume, and atomic number of the material and is based on a type of the material. Interactions of x-rays are highly dependent on the atomic number of the material, but the more the material that is present (volume) the more the number of interactions that occur. Similarly, the more material packed into the volume (density) the more interactions will occur. In the context of x-ray inspection systems, a material with a higher atomic number (Z) attenuates an impinging x-ray beam more than a material with a lower atomic number. It is known that the energy of the x-ray beam also affects the attenuation caused by materials being imaged, wherein high-energy x-ray beams are attenuated less than low-energy x-ray beams. In embodiments, the method of the present specification generates a 3D model of a threat item being imaged in an x-ray inspection system, wherein the attenuation of x-ray beam by each material in the threat item is dependent upon the energy of the x-ray beam, the atomic number of the material and the density of the material. In embodiments, a transparency value for each material in the threat item is obtained through comparisons to corresponding material in radiographic images to approximate the grayscale or transparency value required for generating a 3D model of the threat item. In an embodiment the obtained grayscale values for materials constituting the threat item are stored in a library for future use. In some embodiments, transparency values for most materials that are known to constitute threat items are obtained and stored in the library. Some examples of the materials for which the transparency values are obtained include, and are not limited to, metals, wood, and plastic, which are the main materials for contraband such as firearms.

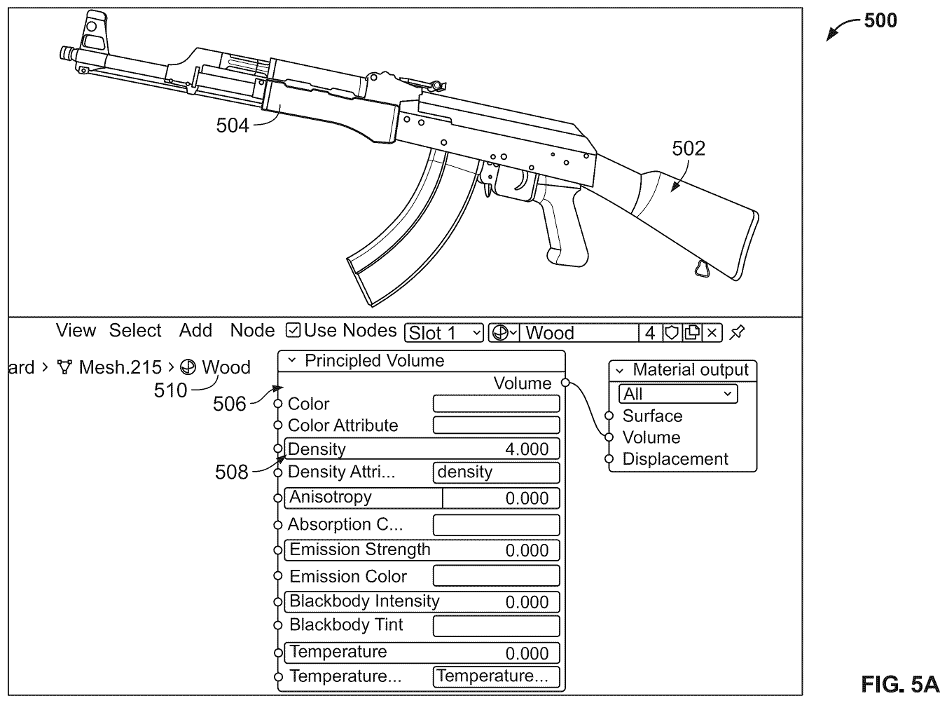

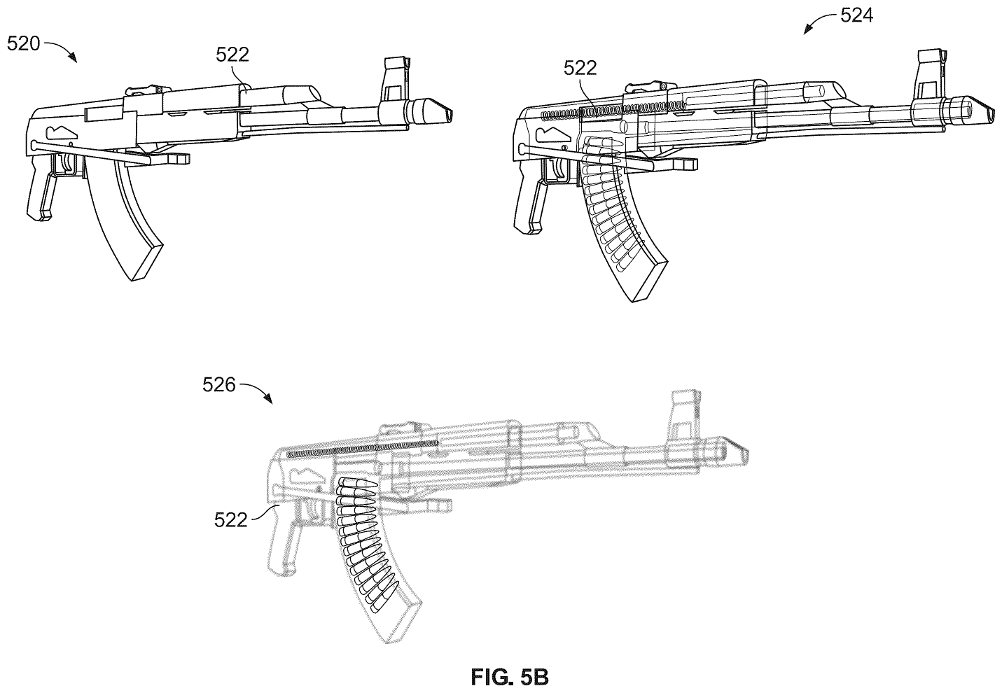

FIG. 5A is a graphical user interface of an exemplary software application that is used to generate a 3D model of a threat item, in accordance with an embodiment of the present specification. In an embodiment, a software application such as, but not limited to ‘Blender™’, which is a software tool commercially available for constructing 3D models, is used to generate a 3D model of a synthetic threat item, such as, a firearm 502, as shown in a screenshot 500 of the software application. A selected portion 504 of the firearm 502 is shaded by using specific parameters such as, but not limited to color, color attribute, density, density attribute, anisotropy, absorption, emission strength, emission color, blackbody intensity, blackbody tint, and temperature, which are input into the software application. The shading is performed manually and with prior knowledge of the materials being used in the synthetic threat item. In embodiments, the input parameters correspond to the volume of the threat item, contrary to the common practice during generation of 3D model for animation or computer games of linking the input parameters (such as colour of texture) to a ‘surface’ of the item being modeled. In various embodiments, the specific parameters required to be input are dependent upon the software tool being used.

Screenshot 500 comprises a portion 506 illustrating a transparency value denoted as ‘density’ 508 which is defined as ‘4’ for the material of the selected portion 504, which is further defined as ‘wood’ 510. For other portions of the firearm 502 which are made of metal, specifically steel, the density value may be defined as ‘25’. In an embodiment, the density values of various materials that comprise the firearm 502 are obtained via comparisons made with actual radiographic images for the same materials where the x-ray images were generated using 6 MeV x-ray beams. The defined density and/or transparency values are not exclusive to the specific materials and are dependent upon the energy of x-ray beams and the design of inspection systems used to obtain the radiographic images.

FIG. 5B illustrates a CG model of an assault rifle, in accordance with an embodiment of the present specification that was generated using the software application of FIG. 5A. Section 520 illustrates an outer skin of an assault rifle 522. Section 524 illustrates a transparent view of the assault rifle 522. Section 526 illustrates an x-ray like view of the assault rifle 522, wherein a transparency of the rifle 522 in the view 526 is dependent on the types of material from which the rifle 522 is made.

Referring back to FIG. 4, at step 406, an orientation of the 3D model is changed. In embodiments, each rendered 2D image corresponds to the 3D image of the threat item positioned at a varying/different orientation along x, y and z axes, thus enabling the AI-based screening tools to learn to identify key features of the threat item at any angle, thereby leading to accurate identification of the threat item. Since, it is not possible to predict an orientation of a threat item that is being screened in a real life situation, it is advantageous to provide the AI screening tool with a plurality of orientations of synthetic images of the threat item to enable efficient learning and accurate identification of the item. Alternatively, a point in 3D space which looks directly at the 3D object is chosen for at least one 2D image to be obtained.

At step 408, the 3D model is rendered into a predefined number of 2D radiographic-like images. A frame size is set to ensure the full 3D object is captured in the image, after which the 2D image is obtained. The 3D object may then be re-oriented and subsequently photographed, obtaining a different image of the object from a different angle. Alternatively, the 3D image of the threat item (the 3D object) remains in a fixed position but the viewpoint changes to multiple positions in the 3D space surrounding the 3D image, to obtain multiple 2D images of the image from different angles. The method used herein enables building a library of 2D images of the corresponding threat item positioned at different orientations, or viewed from different angles. The task of either re-orienting the 3D object to obtain 2D images, or obtaining 2D images from multiple points of view in the 3D space surrounding the 3D object image, is performed either manually by a user using an user-interface to the CGI tool, or is performed by a software routine. In one embodiment, Blender™ can use Python scripts to change 3D object orientations and render many 2D images. In a preferred embodiment, a software routine is used to automatically move the virtual 3D object, or the camera angle or viewpoint, into various random orientations and, once the virtual 3D object, camera angle or viewpoint is modified to a new orientation, a software routine is further used to automatically render or generate a 2D image which captures the virtual 3D object in the new orientation.

In embodiments, the 2D images produced may be inserted into normal stream-of-commerce radiographic data for use in a TIP process.

In embodiments, the orientations of the 3D model may be controlled by rotation of the x, y, and z axes, values of which may be varied individually between 0 and 360 degrees. A large number of orientations of the 3D model would provide a correspondingly large number of 2D renderings of the model, which are preferably radiographic like images. A radiographic like image is one that visually appears to be generated from, but is not in fact generated from, a X-ray scanning system or other form of radiation scanning system. For example, if the 3D model is rendered every 1 degree, a total of 360×360×360 2D images may be generated. In other embodiments, the 3D model may be rendered at values less than 1 degree along each axis to obtain an even larger number of 2D images. In a preferred embodiment, an orientation of the 3D model is changed every 30 degrees in order to render a requisite number of 2D images. In embodiments, a requisite number of 2D images is dependent upon the AI-based screening tool being trained to identify threat items. In an embodiment, the orientation of the 3D model may be achieved automatically using a predefined script.

In an embodiment, 3D models are configured manually. For example, a firearm may or may not contain bullets/magazine and/or the firearm stock or barrel may have different styles depending on its usage. In such cases, the parts of the corresponding 3D model may need to be changed manually.

Radiographic images in real life scenarios are generated using x-ray inspection systems comprising an x-ray source and detectors. Both the source and the detectors emanate fluctuations, which may be electrical, or based on efficiency/stability of the x-ray inspection system. The fluctuations can be seen in the generated radiographic images as noise. Noise levels in radiographic images are dependent upon a plurality of factors such as, but not limited to x-ray dose in the inspection system wherein higher x-ray intensities lead to lower noise levels. The noise level may be characterized based on the x-ray signal observed on the x-ray detectors in the inspection system, wherein noise=sqrt (signal) x factor, where the factor varies depending on the characteristics of the x-ray inspection system (output dose of the source and detector types).

In embodiments, the radiographic images synthetically generated using CGI do not comprise any noise elements. Hence, in embodiments, to make the synthetic images appear realistic, noise elements are added to the images. In an embodiment, for the 2D radiographic-like images rendered directly from the 3D models, noise is added after the 2D images are constructed. In an embodiment, methods such as, but not limited to, filtering and/or randomizing may be used to add noise to the rendered 2D images. In an embodiment, Box-Muller transformation may be used for generating Gaussian distributions that are similar to the observed noise in radiographic images. In some embodiments, noise levels in the rendered 2D images are adjusted by comparing with real radiographic images, while in other embodiments, the noise levels are randomized to produce a variety of different quality images for training with AI-based models.

A size of a rendered 2D image is dependent on the software used to create the image and may be on the order of 1 mega pixel or more. An x-ray scanner's resolution is dependent on the size of detectors used in the system and sample rates of the detectors. The resolution of images of threat items generated by an x-ray scanner also varies based on a position of the threat items with respect to the x-ray source of the scanner, while the threat items are being scanned. This is due to a magnification effect. If a threat item is placed close to the x-ray source, the item will appear larger in the corresponding radiographic image and will have a better resolution than if the item is placed further away from the x-ray source. The magnification effect becomes significant when large items such as, but not limited to, containers which are approximately 2.5 meters in width, are being scanned.

Referring back to FIG. 4, at step 410, each generated 2D radiographic like image is re-sized to fit with a predefined resolution of x-ray scanners used for imaging threat items. In embodiments, the re-sizing is randomized to fit a variety of screening models/systems, thus enabling AI models to generalize during training. A magnification of the threat item placed in a scanning tunnel leads to a determination of the range of the size/resolution of the corresponding radiographic images produced. The image resolution is measured from the center of the scanning tunnel, which is effectively equivalent to a center of a cargo container being scanned. In embodiments, randomizing resizing of the 2D radiographic-like image enables obtaining images of threat item placed at different positions within the cargo. In an embodiment, randomizing resizing of the 2D radiographic like image enables obtaining images of threat item as close to the x-ray source as possible, but still within the cargo, as well as the threat item being placed as far away from the x-ray source as possible, but still within the cargo.

Specifically, for the TIP process the 2D radiographic-like images are re-sized in accordance with predefined specifications, based on image resolutions obtained from actual x-ray inspection systems, as illicit materials and/or threat items are required to be of a realistic size compared to their surroundings when being inserted into SoC images. In embodiments, manipulation of the rendered 2D radiographic like images may be performed in software applications such as but not limited to, ‘MATLAB’ in order to change the resolution of the images.

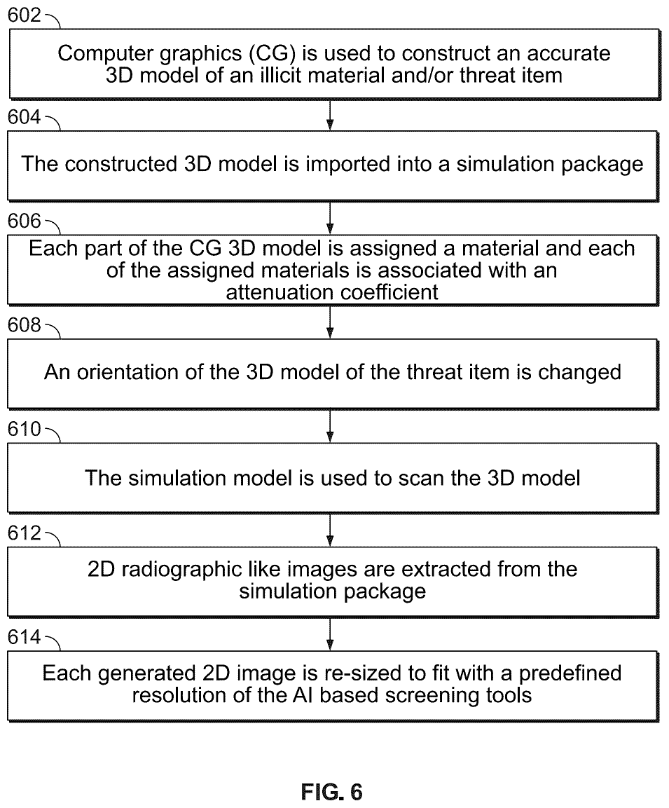

FIG. 6 is a flowchart detailing the steps of a method for generating a 3D model of a threat item that may be used to obtain 2D radiographic-like images of the threat item by using a simulation software application, in accordance with an embodiment of the present specification. At step 602, a computer graphics imaging (CGI) technique is used to construct an accurate 3D model of an illicit material/threat item. In an embodiment, the 3D model is acquired from a third party.

At step 604 the constructed/acquired 3D model is imported into a simulation software application. In an embodiment, a Monte-Carlo simulation application is used. In other embodiments a suitable computer game development software application may be used by providing the software application with inputs corresponding to an x-ray inspection system such as, but not limited to, x-ray beam energies and distributions, and material attenuation coefficients.

In an embodiment, a simulation software application named ‘Unity’, used for producing computer games, is used to construct said 3D models. A graphical user interface (GUI) corresponding to the simulation software application, enables users to input dimensions, or geometry of an x-ray inspection system, in order to obtain a 2D radiographic like image with approximately the same perspective as a real x-ray inspection system. In other embodiments, other software applications providing similar functionalities, or simulation applications which contain a greater detail of physics, such as but not limited to, Geant4, may be used to achieve the methods of the present specification.

At step 606, each part of the CGI 3D model is assigned a material and each of the assigned materials is associated with an attenuation coefficient. For example, in cases where a Monte-Carlo simulation software application is employed, the predefined physics libraries of the software determine the manner in which x-rays interact with each material in order to obtain an attenuation coefficient corresponding to each material in the 3D model. In embodiments where a suitable computer games development software application is used, a built-in library of attenuation coefficients within the software application is used to obtain an attenuation coefficient corresponding to each material in the 3D model. The library of attenuation coefficients is built within the software application by the developer. Attenuation coefficients for materials at different x-ray energies may be obtained from on-line sources such as, but not limited to, website of National Institute of Standards and Technology (NIST). The Attenuation coefficients are downloaded and stored as a look-up table in the software application by the developer. The look-up table may be used to extract corresponding attenuation coefficients of each material in the 3D model.

At step 608, an orientation of the 3D model of the threat item is changed. In embodiments, the orientations of the 3D model may be controlled by rotation of the x, y, and z axis, values of which may be varied individually between 0 and 360 degrees, automatically. A large number of orientations of the 3D model would provide a correspondingly large number of 2D renderings (radiographic images) of the model.

At step 610, the simulation software is used to scan the 3D model. In an embodiment, a simulation application which incorporates some or all of the known physical aspects required to generate a radiographic-like image from the 3D model, is used to scan the 3D model. In embodiments, x-ray detectors are simulated, and signals from the simulated detectors are extracted to produce the radiographic-like images directly.

In embodiments, where a customized software computer game package is used as the simulation software, a ray tracing routine is employed to scan the 3D model. The ray tracing routine comprises tracing the path from an x-ray source to an individual detector, and calculating a thickness of all constituent materials of an object being scanned, positioned between the source and detectors, for obtaining attenuation of the x-ray beam by the constituent materials. A final value of x-ray intensity received at each individual detector is also determined. The object being scanned is then moved forward towards the detectors by a small predetermined value, and the ray tracing is repeated, after completion of which, the object is moved further towards the detectors. This process is repeated until the full object has been ‘scanned’.

In some embodiments, a Monte-Carlo simulation package, which comprises customized physics libraries, is used as the simulation software and is configured to scan the 3D model. By using the simulation package, scanning of an object commences with a photon (x-ray) leaving an x-ray source, which is recorded as an event, and the photon interacting with all constituent materials of the object being scanned positioned between the source and detectors. The path of the photon is tracked, and if the photon reaches any of the detectors, a detection signal is generated via interaction of the photon with the detector. The object being scanned is not moved until a predefined number of events as determined by a user, have been recorded.

At step 612, 2D radiographic like images are extracted from the simulation application. At step 614, each generated 2D radiographic like image is re-sized to fit with a predefined resolution of the AI based screening tools. In embodiments, the re-sizing is randomized to fit a variety of training models/systems in order to enable AI models to generalize during training. Specifically, for the TIP process the 2D images are re-sized in accordance with predefined specifications, based on image resolutions obtained from actual x-ray inspection systems, as illicit materials and/or threat items are required to be of a realistic size compared to their surroundings when injected into SoC images.

In embodiments, in order to make the synthetic images appear realistic, noise elements are added to the images. Noise may be added at various stages of image construction in a simulation application, depending on the level of physics embedded in the simulation software application.

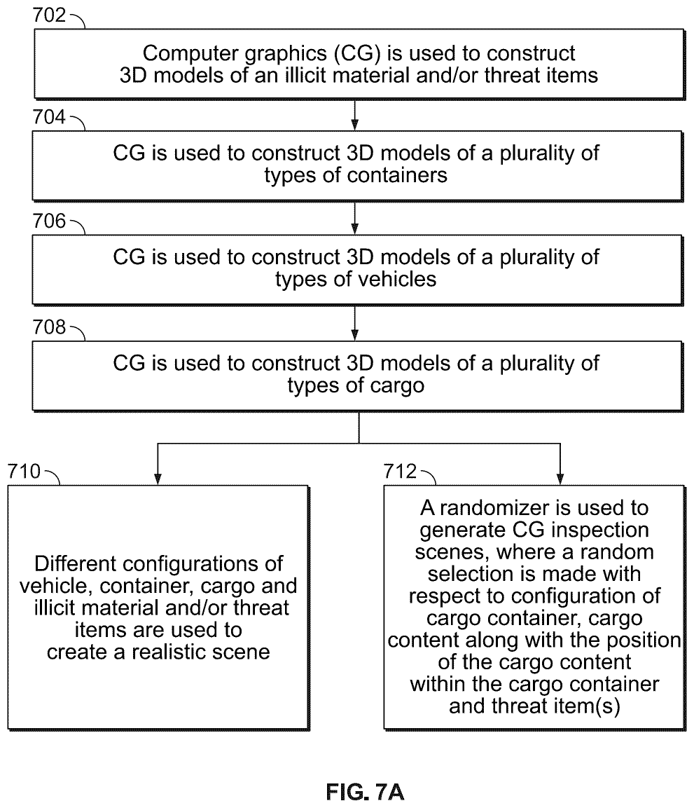

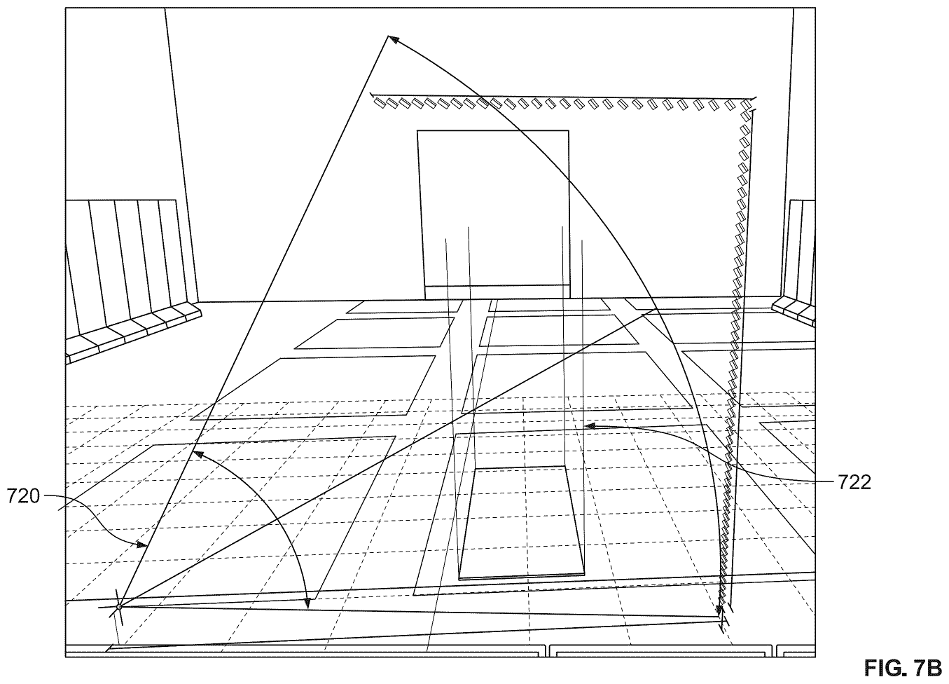

FIG. 7A is a flowchart detailing steps of a method for using CGI to generate radiographic like images of cargo containers and vehicles containing threat items, in accordance with an embodiment of the present specification. In embodiments, the method of the present specification enables generation of realistic smuggling scenarios, wherein vehicles, cargo, and containers are being used to hide threat items, by using CGI. At step 702, computer graphics imaging (CGI) is used to construct 3D models of illicit materials and/or threat items. At step 704, CGI is used to construct 3D models of a plurality of types of containers. At step 706, CGI is used to construct 3D models of a plurality of types of vehicles. At step 708, CGI is used to construct 3D models of a plurality of types of cargo. In an embodiment, the 3D models are acquired from a third party.

At step 710, different configurations of the 3D models of vehicle, container, cargo and illicit materials and/or threat items are used to create a realistic inspection scenario. As is known, large scale x-ray scanners use x-ray beams that are fan shaped in a vertical direction. Due to the large vertical x-ray distribution, perspective is observed in the vertical direction only. The x-ray beam is narrow in the horizontal direction, and hence, no perspective is observed in the horizontal direction. As vehicles, cargo, and containers are large in size, it is essential that during construction of the 3D models, the CGI environment matches the geometry of a working real-world x-ray scanner, in order to generate 2D radiographic-like images (from the 3D models) having the same perspective as the real-world x-ray scanner. FIG. 7B illustrates an X-ray source and detector array pictured in a simulation application for simulating a transmission style x-ray inspection system, in accordance with an embodiment of the present specification. As shown in FIG. 7B an x-ray fan beam 720 is being used to scan a test piece 722.

Referring back to FIG. 7A, at step 712, a randomizer is used to generate CGI inspection scenes, where a random selection is made with respect to configuration of cargo container, cargo content along with the position of the cargo content within the cargo container, and threat item(s). By using a randomizer to generate a CGI based inspection scenario, a plurality of scenarios, wherein no two scenarios are the same, may be generated, thereby providing a variety of resultant 2D radiographic-like images for the AI model to train on.

In various embodiments, either or both steps 710 and 712 may be used to create a CGI based inspection scenario comprising 3D models of vehicles, cargo, containers hiding threat items.

Once a realistic inspection scenario comprising 3D models is constructed by using the above steps, 2D radiographic-like images may be generated from the 3D models either: by directly rendering the images from the 3D models by following the steps illustrated in FIG. 4; or by using a simulation application as shown in FIG. 6.

The above examples are merely illustrative of the many applications of the system of present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

What is claimed is:

1. A method for generating two dimensional (2D) radiographic-like images of an item from a three dimensional (3D) virtual model of the item, the method comprising:
constructing the virtual 3D model of the item, wherein the item is an illicit material and/or threat item, by using a computer graphics (CG) process;
modifying a degree of visual transparency of the virtual 3D model;
modifying an orientation of the virtual 3D model more than once; and
upon the virtual 3D model adopting each modified orientation, automatically rendering the virtual 3D model to generate at least one of the 2D radiographic-like images representative of said modified orientation, wherein a number of the generated 2D radiographic-like images is dependent upon a number of times the orientation of the virtual 3D model is modified.

2. The method of claim 1, further comprising importing the constructed virtual 3D model into a simulation software application.

3. The method of claim 2, further comprising assigning each part of the virtual 3D model a distinct material composition type.

4. The method of claim 3, further comprising associating each of the assigned distinct material composition type with a corresponding attenuation coefficient.

5. The method of claim 4, further comprising after changing the orientation of the virtual 3D model, scanning the virtual 3D model by using a simulation software application.

6. The method of claim 5, wherein rendering the virtual 3D model to generate the 2D radiographic-like image comprises extracting the 2D radiographic-like image from the simulation software application.

7. The method of claim 2, wherein the simulation software application is a Monte-Carlo type simulation application.

8. The method of claim 1, further comprising adding a noise element to the generated 2D radiographic-like image.

9. The method of claim 8, further comprising adding said noise element using a filtering process or a randomizing process.

10. The method of claim 1, further comprising re-sizing the generated 2D radiographic-like image to fit with a predefined resolution of one or more machine learning based inspection tools.

11. A method for generating a plurality of two dimensional (2D) radiographic-like images of an item from a virtual 3D model of the item, the method comprising:
constructing the virtual 3D model of the item, wherein the item is an illicit material and/or threat item, by using a computer graphics (CG) process;
importing the constructed virtual 3D model into a simulation software application;
assigning each part of the virtual 3D model a distinct material composition type;
associating each of the assigned distinct material composition types with a corresponding attenuation coefficient;
modifying an orientation of the virtual 3D model one or more times;
scanning the virtual 3D model using the simulation software application; and
automatically generating the plurality of 2D radiographic-like images from the simulation software application.

12. The method of claim 11, wherein the simulation software application is a Monte-Carlo type simulation application.

13. The method of claim 11, wherein a number of the plurality of 2D radiographic like images generated is dependent upon a number of times the orientation of the virtual 3D model is modified.

14. The method of claim 11, further comprising adding a noise element to each of the generated plurality of 2D radiographic like images.

15. The method of claim 14, wherein said noise element is added using a filtering process or a randomizing process.

16. The method of claim 11, further comprising re-sizing each of the generated plurality of 2D radiographic like images to fit with a predefined resolution of one or more machine learning based inspection tools.

17. A method of generating radiographic-like images of vehicles and cargos containers containing threat items, the method comprising:
generating three-dimensional (3D) models of a plurality of types of threat items using a computer graphics (CG) process;
generating 3D models of a plurality of types of vehicles by using said CG process;
generating 3D models of a plurality of types of cargo containers by using said CG process;
generating realistic inspection scenarios using multiple configurations of the different 3D models of the plurality of types of threat items, 3D models of the plurality of types of vehicles, and 3D models of the plurality of types of cargo containers; and
generating two dimensional radiographic-like images from said realistic inspection scenarios.

18. The method of claim 17, wherein generating realistic inspection scenarios is achieved by using a randomizer to make random selections of configurations of the 3D models of the plurality of types of vehicles and 3D models of the plurality of types of cargo containers and positions of the 3D models of the plurality of types of threat items within the 3D models of the plurality of types of vehicles and the 3D models of the plurality of types of cargo containers.

19. The method of claim 17, wherein generating the radiographic like images comprises rendering 3D models representing realistic inspection scenarios and generating each of the 2D radiographic like images from said 3D models representing realistic inspection scenarios.

20. The method of claim 19, wherein generating the two dimensional radiographic like images comprises:
importing the 3D models representing realistic inspection scenarios into the simulation software application;
assigning each part of the 3D models representing realistic inspection scenarios a distinct material composition type;
associating each of the assigned materials with a corresponding attenuation coefficient;
changing orientation of the 3D models representing realistic inspection scenarios at least once;
scanning the 3D models representing realistic inspection scenarios using the simulation software application; and
extracting the 2D radiographic like images from the simulation software application.
